(19) United States
(12) Patent Application Publication
(10) Pub. No.: US 2024/0119865 A1
(43) Pub. Date: Apr. 11, 2024

(54) SYNTHETIC BLOOD CLOT

(71) Applicant: Life Model Designs LLC, Marengo, OH (US)

(72) Inventor: Sean P. Gerke, Marengo, OH (US)

(21) Appl. No.: 18/482,320

(22) Filed: Oct. 6, 2023

Related U.S. Application Data
(60) Provisional application No. 63/414,358, filed on Oct. 7, 2022.

(51) Int. Cl. G09B 23/30; C08K 3/02; C08K 3/30; C08L 89/06

(52) U.S. Cl. CPC G09B 23/30; C08K 3/02; C08K 3/30; C08L 89/06; C08K 2003/3045; C08L 2205/035

(57) ABSTRACT

A synthetic blood clot and its corresponding method of formulation are described that provide a thrombus simulant capable of being used in synthetic biological pathways, such as for surgery training and/or simulation testing purposes. In one example embodiment, non-biohazardous ingredients such as one or more hydrogels, other thickening agents, coloring agents, and water are combined to form the thrombus simulant. A radiolucent agent may be provided to permit visualization of the thrombus simulant under certain imaging techniques, such as x-rays.

### CROSS-REFERENCE TO RELATED APPLICATIONS

This non-provisional application claims priority to U.S. Provisional Application Ser. No. 63/414,358, filed on Oct. 7, 2022, the disclosure of which is incorporated by reference as if fully recited herein.

### TECHNICAL FIELD

The present invention relates generally to a synthetic blood clot, and more particularly to a formulation of non-biohazardous ingredients combined to define synthetic material suitable for use as a thrombus simulant. In one example embodiment, one or more hydrogels and/or thickening agents are combined with water and a coloring agent to form thrombus simulant, which may be introduced to any number of different synthetic biological pathways for surgery training and/or simulation testing purposes.

### BACKGROUND AND SUMMARY OF THE INVENTION

A blood clot (also referred to herein in the singular as “thrombus” and in the plural as “thrombi”) is a coagulation of aggregated platelets and red blood cells. Thrombi are known to form in response to cuts, lacerations, and the like to reduce and/or stop bleeding. Although thrombi are important to address bleeding after an injury, a common health problem called thrombosis occurs when one or more blood clots impede blood flow through a blood vessel. Thrombosis may result from serious injuries, infections, sepsis, lack of mobility, pregnancy, animal venom, some combination thereof, or the like. If not treated, thrombosis may cause breathing problems, heart attacks, strokes, and the like, issues which often prove deadly. Anticoagulants (e.g., Heparin and Warfarin) are often used to address thrombosis, but anticoagulants may be insufficient to resolve the thrombosis and/or may present bleeding risks to the patient taking them.

To address thrombosis in many cases, particularly when anticoagulants by themselves prove insufficient to resolve thrombosis, medical professionals employ a surgical procedure to remove the thrombosis (e.g., mechanical thrombectomy). Mechanical thrombectomy may involve the use of a catheter or microcatheter linked to a suction, angioplasty, stent retriever (e.g., including a wire mesh), some combination thereof, or the like device. The catheter/microcatheter may be introduced to the blood vessel experiencing a blood clot, and the suction, angioplasty, stent retriever, some combination thereof, or the like device may be positioned on or proximate to the problematic thrombus. Thereafter, the suction, angioplasty, stent retriever, some combination thereof, or the like device may remove the thrombus, and/or assist with said removal. A significant amount of training is required before a medical professional may be trusted to safely perform any surgical procedure, especially a mechanical thrombectomy.

Traditionally, trainees (e.g., vascular surgeon trainees) and researchers in the relevant field had limited to no access to techniques involving materials realistically simulating the presence of human blood clots, such as, e.g., for practicing blood clot removal from a synthetic blood vessel. Known thrombectomy training techniques involving animal models have been problematic for both economic and ethical reasons, in addition to the fact that human anatomy differs greatly from that of other animals. To address these issues, medical professionals have employed a technique involving introducing thrombi generated in vitro from real blood into simple flow models or more complex physical simulation models reflecting human anatomy. For example, blood may be drawn from a non-human mammal (e.g., a pig), and thrombi may be generated in vitro from said blood according to known techniques.

Issues with the aforementioned known technique include that lab-generated thrombi from real blood have a very limited shelf life, are expensive, and are generally considered biohazardous. Another issue is that the aforementioned technique requires drawing blood from a live animal, which may be unpleasant for the animal. Yet another issue is that animal thrombi may not accurately represent human thrombi. There have been attempts to generate synthetic thrombi, but known synthetic thrombi may only have limited accuracy with respect to simulating real human thrombi.

The aforementioned shortcomings speak to the need for a synthetic blood clot, capable of being used in any number of different synthetic biological pathways for surgical training and/or thrombus simulation purposes.

In view of this, it is beneficial to have a novel synthetic material involving, e.g., a combination of one or more hydrogels and/or thickening agents, water, and a coloring agent for simulating any number of different human thrombi, including, for example, newly formed thrombi, acute thrombi, chronic thrombi, some combination thereof, or the like.

According to the present invention in one aspect, a synthetic material suitable for use as a thrombus simulant is created from a combination of water, hydrolyzed collagen, one or more additional hydrogels and/or thickening agents, and a coloring agent. The combination may be heated and then cooled to form the thrombus simulant. The coloring agent may be introduced to the combination before or during the cooling process. The synthetic material may also include a radiolucent agent and/or an optical brightener. The synthetic material may replicate properties of newly formed thrombi, acute thrombi, and/or chronic thrombi, and may be configured to have a shelf-life of at least six weeks.

According to the present invention in another aspect, a method of forming a synthetic material suitable for use as a thrombus simulant comprises providing water, providing at least one selected from the group of hydrolyzed collagen, gellan gum, xanthan gum, agar agar, and guar gum, and providing a coloring agent. The water (e.g., DI water) may be combined with the at least one selected from the group of hydrolyzed collagen, gellan gum, xanthan gum, agar agar, and guar gum. The aforementioned combination may be heated (e.g., using a hot plate, oven, some combination thereof, or the like) and then cooled to form a mass of the synthetic material. The coloring agent may be introduced to the combination before or during the cooling process.

Exemplary embodiments of the present invention may be advantageous, for example, for providing material realistically simulating human thrombi for various practice blood clot removal procedures (e.g., practice mechanical thrombectomy). The practice procedures may involve synthetic blood vessels and blood simulant coupled with exemplary synthetic thrombi. The practice procedures may be performed by vascular surgeon or similar physician trainees. An exemplary synthetic thrombus comprises relatively inexpensive, non-biohazardous materials, has an extensive shelf life (e.g., about 6-8 weeks), and is less expensive to generate compared to a lab-generated thrombus derived from real blood. An exemplary embodiment has no requirement for animal blood to be drawn. An exemplary embodiment may further provide researchers in the relevant field a means to simulate and study blood clot behavior without having to perform any in vivo testing/procedures. Other advantages of exemplary embodiments of the present invention will become apparent to those of ordinary skill in the art based on the present disclosure.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a top perspective view of exemplary thrombi simulant of the present invention;

FIG. 2 illustrates a perspective view of other exemplary thrombi simulant of the present invention;

FIG. 3 illustrates a perspective view of yet another exemplary thrombus simulant of the present invention;

FIG. 4 illustrates a perspective view of exemplary fluorescent thrombi simulant of the present invention;

FIG. 5 illustrates a perspective view of a clot injector capable of being used to introduce an exemplary thrombus simulant to any number of different synthetic biological pathways;

FIG. 6 illustrates a perspective view of another clot injector capable of being used to introduce an exemplary thrombus simulant to any number of different synthetic biological pathways;

FIG. 7 illustrates a perspective view of yet another clot injector capable of being used to introduce an exemplary thrombus simulant to any number of different synthetic biological pathways;

FIG. 8 illustrates a perspective view of yet another clot injector capable of being used to introduce an exemplary thrombus simulant to any number of different synthetic biological pathways;

FIG. 9 illustrates a top plan view of a synthetic biological pathway capable of receiving an exemplary thrombus simulant;

FIG. 10 illustrates a front elevational view of an exemplary thrombus simulant being introduced to a synthetic biological pathway by way of a clot injector; and

FIG. 11 illustrates a table of exemplary ingredients, configured to be combined to provide an exemplary thrombus simulant.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

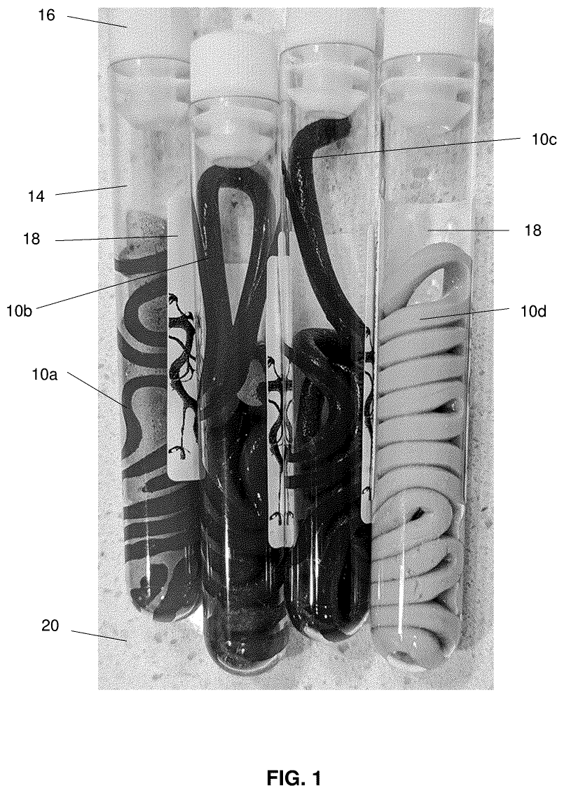

Referring initially to FIG. 1, several vials 14 each storing an exemplary thrombus simulant 10a-d are shown positioned over a table 20. Here, the vials 14 each include a lid 16 configured to contain the thrombus simulant 10a-d within each vial 14. The vials shown further comprise a label sticker 18. The vials 14 are preferably transparent, and may be assembled from any number of different materials. It will be apparent to one of ordinary skill in the art that there may be any number of different vials, other containers or storage devices available for storing exemplary thrombus simulant without departing from the scope of the present invention. As demonstrated, variations to the length, diameter, shape, color and the like of the thrombus simulant 10a-d may be made without departing from the scope of the present invention. The thrombus simulant (e.g., 10a-d) may be stored with any number of different mediums, such as, for example, a saline solution, oil, some combination thereof, or the like.

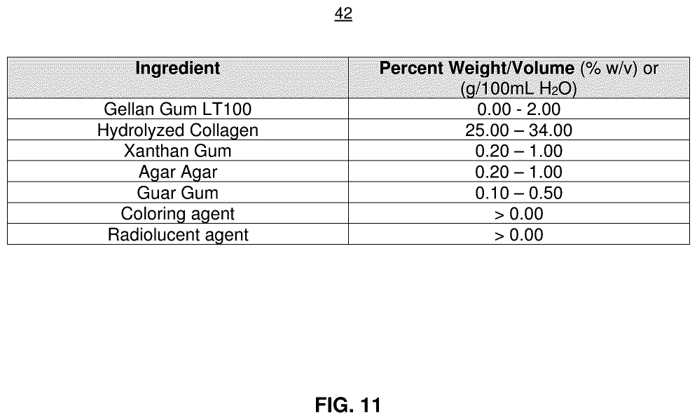

Referring now to FIG. 11, an exemplary formulation table 42 is shown. In this particular embodiment, the ingredients to formulate an exemplary thrombus simulant are each non-biohazardous. In contrast, an actual human thrombus may comprise fibrin, platelets, and other blood components, and may be biohazardous, requiring controlled disposal. Referring now to FIGS. 1 and 11, an exemplary thrombus simulant (e.g., 10a-d) may be formulated using the ingredients from table 42, and may be viscous and elastic, similar to an actual human thrombus. Furthermore, similar to an actual human thrombus, exemplary thrombus simulant (e.g., 10a-d) may demonstrate similar stress-strain relationships, elastic moduli, friction properties (e.g., between the thrombus and a synthetic vessel wall), density, fragmentation properties, some combination thereof, or the like compared to actual human thrombi.

Each thrombus simulant (e.g., 10a-d) may be generated with any number of different specific properties to simulate human thrombi of varying origins and composition. In this particular embodiment, the thrombi simulant 10a-d is created from a combination of food-grade hydrogels, thickening agents, water, and a coloring agent. It will be apparent to one of ordinary skill in the art that variations may be made to the types and amounts of hydrogels and/or thickening agents used, and the amount of water used without departing from the scope of the present invention. It will further be apparent to one of ordinary skill in the art that a coloring agent, although preferred, is not necessarily required in other embodiments.

Exemplary synthetic thrombi (e.g., 10a-d) may replicate properties of actual human newly formed thrombi, acute thrombi, chronic thrombi, some combination thereof, or the like. Exemplary synthetic thrombi (e.g., 10a-d) may be introduced to any number of different training modules to assist vascular surgeon or the like trainees in performing mock thrombectomy or the like procedures. Exemplary synthetic thrombi (e.g., 10a-d) may additionally or alternatively be introduced to any number of different simulation modules to assist medical researchers in observing thrombi behavior in a controlled, non-biohazardous environment (e.g., involving synthetic blood vessels). Certain exemplary synthetic thrombi have a shelf-life of 6 to 8 weeks, where haptic properties of the synthetic thrombi resembling those of actual human thrombi are maintained during said period.

In this particular embodiment, the thrombus simulant (ingredients shown in table 42—also shown in TABLE I below) comprises up to 2% w/v (or g/100 mL H₂O) of gellan gum (e.g., LT100), up to 34% w/v of hydrolyzed collagen, up to 1% w/v of xanthan gum, up to 1% w/v of agar agar, up to 0.5% w/v of guar gum, and a coloring agent to promote a realistic appearance of the synthetic thrombus. A radiolucent agent (e.g., iodine, barium sulfate, some combination thereof, or the like) may also be introduced to permit visualization of the synthetic thrombus under certain imaging techniques, such as x-rays. An actual blood clot removal procedure may be performed under digital subtraction angiography, and iodine containing contrast medium may be injected into a patient's arteries using a catheter, which may permit x-ray imagery of the patient's vasculature. Thus, a radiolucent agent may permit x-ray visualization of an exemplary synthetic thrombi during a mock blood clot removal from a synthetic vasculature.

The aforementioned ingredients and percent weight by volumes (and ranges shown in table 42/TABLE I below) are merely illustrative. Variations may be made to an exemplary formulation without departing from the scope of the present invention. For example, a different hydrogel agent may substitute gellan gum and/or hydrolyzed collagen, or be added in addition to gellan gum and/or hydrolyzed collagen. As another non-limiting example, a different thickening agent may substitute xanthan gum, agar agar, and/or guar gum, or be added in addition to xanthan gum, agar agar, and/or guar gum.

TABLE I

| | Percent Weight/Volume (% w/v) or |
|---|---|
| Ingredient | (g/100 mL H₂O) |
| Gellan Gum LT100 | 0.00-2.00 |
| Hydrolyzed Collagen | 25.00-34.00 |
| Xanthan Gum | 0.20-1.00 |
| Agar Agar | 0.20-1.00 |
| Guar Gum | 0.10-0.50 |
| Coloring agent | >0.00 |
| Radiolucent agent | >0.00 |

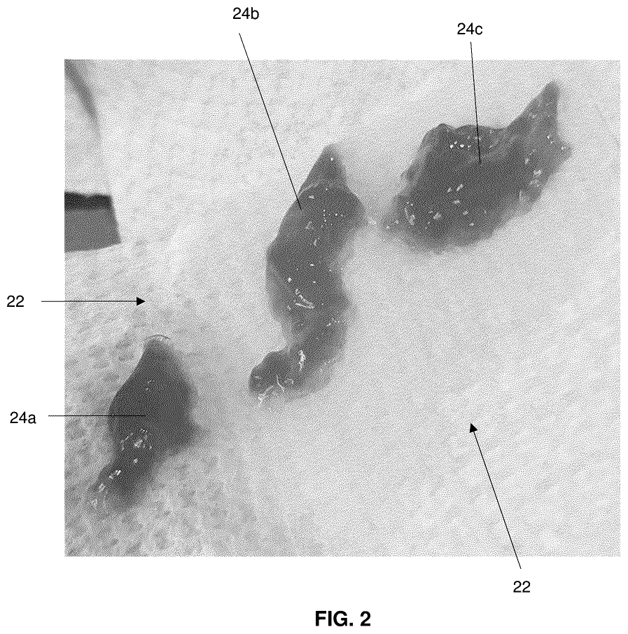

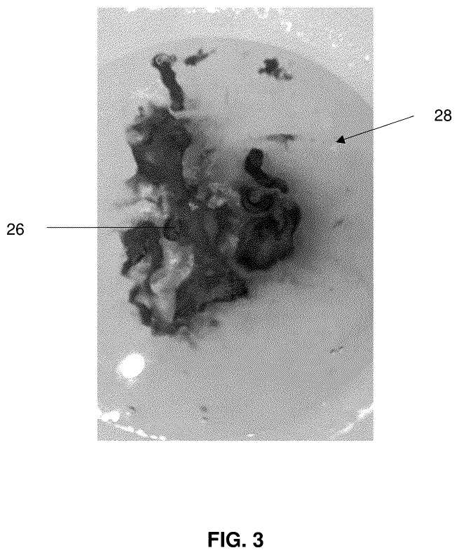

Referring to FIG. 2, several masses of exemplary thrombus simulant 24a-c are shown positioned on a gauze surface 22. Referring to FIG. 3, an amount of exemplary thrombus simulant mixture 28 is shown having a coloring agent 26 being mixed therewith. Referring to FIGS. 2 and 3, variations in the color of an exemplary thrombus simulant (e.g., 24a-c) may be made by adding any number of different types and/or amounts of coloring agents (e.g., 26) to the thrombus simulant during its formation. By way of example and not limitation, dye (e.g., Allura Red AC), pigment (e.g., red pigments), some combination thereof, or the like may provide color to the exemplary thrombus simulant.

The hardness of an exemplary thrombus simulant may range from substantially rigid to very soft and fluid, or somewhere in between. Variations in the hardness of the thrombus simulant may reflect variations in the hardness of actual human thrombi. Variations in hardness, stiffness and compactness of actual human thrombi may relate to variations in calcium and/or fibrin content (e.g., often increase with thrombus age) of the thrombi. Actual human thrombi may demonstrate a diverse range of physical properties. Variations in hardness, stiffness, compactness, friability, another physical property, some combination thereof, or the like of an exemplary thrombus simulant may be controlled by varying the amount/concentration of thickening agent(s) added to the mixture of thrombus simulant ingredients, varying the temperature during which said mixture is permitted to solidify, some combination thereof, or the like. A force gauge may be used to test physical properties of an exemplary thrombus simulant.

Referring back to FIG. 11, in an exemplary embodiment, one or more hydrogel agents (e.g., hydrolyzed collagen and/or gellan gum LT100) and other thickening agents (e.g., xanthan gum, agar agar and/or guar gum) may be mixed (e.g., by vortexing, rotating a graduated cylinder, some combination thereof, or the like) with an amount (e.g., under 100 mL) of water (e.g., cool DI water below 25° C.). The aforementioned mixture may thereafter be heated (e.g., to above 85° C. but below 100° C.) using a hot plate, oven, some combination thereof, or the like. The aforementioned mixture may be temporarily stored at a high temperature (e.g., above 80° C. and below 100° C., such as by placing a container containing said mixture in a hot water bath, oven, hot plate, some combination thereof, or the like) to temporarily maintain said mixture in liquid form, but such is not required.

A coloring agent and/or radiolucent agent (e.g., around 1 mL) may then be added to the aforementioned mixture. Additional water (e.g., hot water above 80° C.) may be added if necessary for the mixture contents to reach a volume of 100 mL (for ease of tracking percent weight/volume of ingredients), but such is not required. The mixture may then be permitted to cool (e.g., at or below 25° C.) for an extended amount of time (e.g., several hours). During or after cooling, the mixture may be formed into any number of different shapes (e.g., using tubes, molds, syringes, cutting devices, some combination thereof, or the like). After cooling, an exemplary thrombus simulant may be placed in a storage container. If desired, an amount of oil may be added to the thrombus simulant to soften it, reduce stickiness of it, some combination thereof, or the like.

Variations to the aforementioned procedure may be made without departing from the scope of the present invention. For example, it is not necessarily required that the one or more hydrogels and/or thickening agents are all mixed and heated together. Certain hydrogels and/or thickening agents may be mixed and heated separately. Furthermore, any number of different heating and/or cooling devices, mixing devices (e.g., pipettes, syringes, measuring containers, and the like) may be employed without departing from the scope of the present invention.

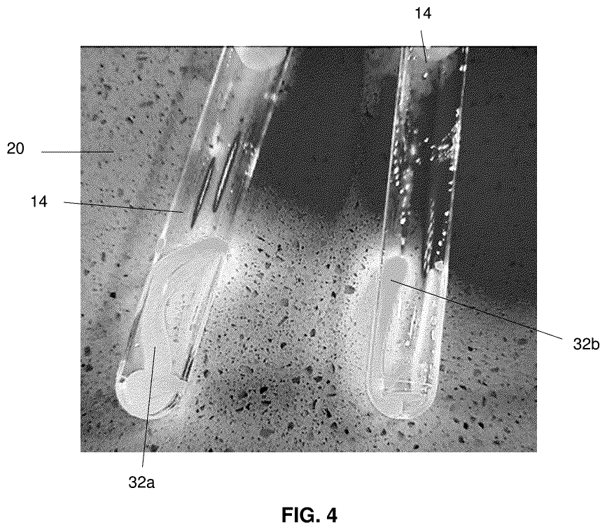

Referring to FIG. 4, a pair of vials 14 each storing an exemplary fluorescent thrombus simulant 32a-b is shown positioned over a table 20. In this particular embodiment, an optical brightener has been added to an exemplary mixture for generating the thrombi simulant 32a-b. An optical brightener may include a fluorescent brightening agent. The addition of one or more optical brighteners may permit visualization of the thrombi simulant (e.g., 32a-b) under certain lighting and/or imaging techniques.

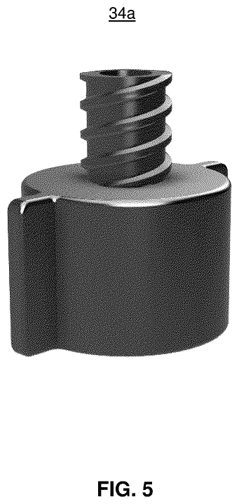

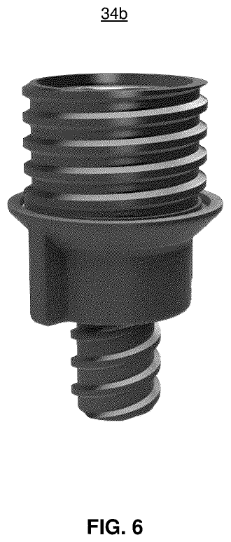

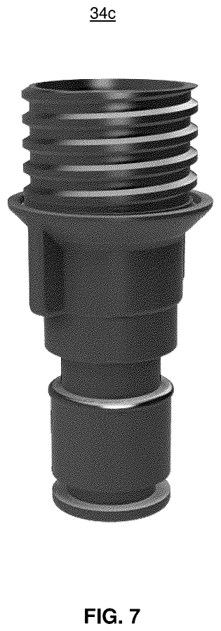

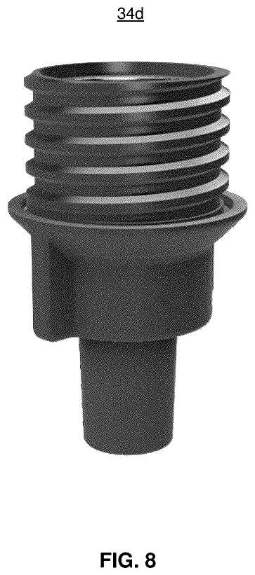

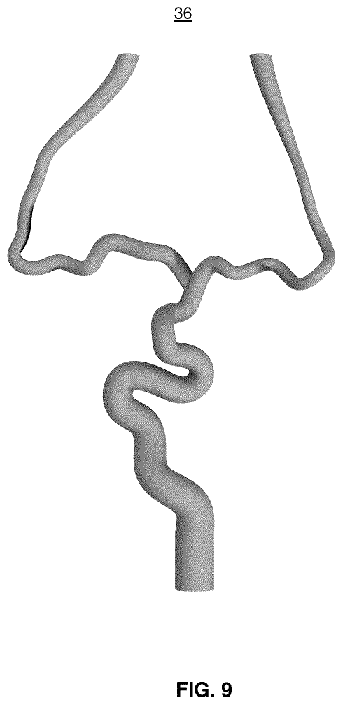

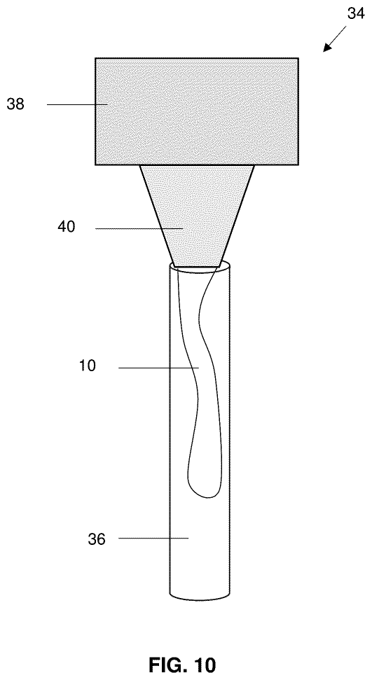

Referring now to FIGS. 5-8, various clot injectors 34a-d are shown. A clot injector (e.g., 34a-d) may permit injection of an exemplary thrombus simulant into a synthetic biological vessel, storage container, some combination thereof, or the like. An exemplary thrombus simulant may be 1-15 mm in diameter, 10 cm in length, and venous in nature, although such is not required. FIG. 9 shows an example synthetic blood vessel 36 comprising non-biohazardous ingredients, and configured to simulate the properties of an actual human blood vessel. FIG. 10 shows an exemplary clot injector 34 comprising a reservoir 38 for receiving and housing thrombus simulant 10, and a nozzle 40 for discharging thrombus simulant 10 into a synthetic blood vessel 36.

Referring now to FIGS. 9 and 10, an exemplary thrombus simulant 10 may be introduced to the vessel 36, along with a blood simulant (not shown), which may be linked to a device (not shown) configured to circulate the blood simulant through the synthetic blood vessel 36. Synthetic atherosclerotic material (not shown) may also be introduced to the synthetic blood vessel 36. The synthetic blood vessel 36 may be transparent to promote training and/or research. Any number of different synthetic biological pathways and related components, and devices and/or techniques configured to introduce exemplary thrombus simulant to a synthetic biological pathway may be employed without departing from the scope of the present invention. It will be apparent to one of ordinary skill in the art that exemplary embodiments of the present invention may be advantageous for other purposes in addition to studying human thrombi behavior and/or practicing human blood clot removal procedures. Non-biohazardous ingredients are preferred, but not necessarily required.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A synthetic material suitable for use as a thrombus simulant, comprising:
water;
hydrolyzed collagen;
at least one selected from the group of gellan gum, xanthan gum, agar agar, and guar gum; and
a coloring agent.

2. The synthetic material of claim 1, wherein the synthetic material comprises up to 34% w/v of hydrolyzed collagen.

3. The synthetic material of claim 1, further comprising a radiolucent agent.

4. The synthetic material of claim 3, wherein the radiolucent agent is at least one selected from the group of iodine and barium sulfate.

5. The synthetic material of claim 1, further comprising an optical brightener.

6. The synthetic material of claim 5, wherein the optical brightener is a fluorescent brightening agent.

7. The synthetic material of claim 1, further comprising:
between 0% and 2% w/v gellan gum;
between 25% and 34% w/v hydrolyzed collagen;
between 0.2% and 1% w/v xanthan gum;
between 0.2% to 1% w/v agar agar; and
between 0.1% and 0.5% w/v guar gum.

8. The synthetic material of claim 7, further comprising at least one selected from the group of a radiolucent agent and an optical brightener.

9. The synthetic material of claim 1, further comprising an amount of at least one selected from the group of an oil and a saline solution.

10. The synthetic material of claim 1, wherein the synthetic material is configured to replicate properties of at least one selected from the group of newly formed thrombi, acute thrombi, and chronic thrombi, and is configured to have a shelf-life of at least six weeks.

11. The synthetic material of claim 1, wherein the synthetic material is 1-15 mm in diameter.

12. The synthetic material of claim 1, wherein the synthetic material is about 10 cm in length.

13. The synthetic material of claim 1, wherein the water, hydrolyzed collagen, and at least one selected from the group of gellan gum, xanthan gum, agar agar, and guar gum are mixed, heated, and cooled to form the synthetic material.

14. A synthetic material suitable for use as a thrombus simulant, comprising:
water;
hydrolyzed collagen, up to 34% w/v thereof;
gellan gum, up to 2% w/v thereof;
xanthan gum, up to 1% w/v thereof;
agar agar, up to 1% w/v thereof;
guar gum, up to 0.5% w/v thereof; and
wherein the water, hydrolyzed collagen, gellan gum, xanthan gum, agar agar, and guar gum are mixed, heated, and cooled to form the synthetic material.

15. The synthetic material of claim 14, further comprising a coloring agent.

16. A method of forming a synthetic material, comprising:
providing water;
providing at least one selected from the group of hydrolyzed collagen, gellan gum, xanthan gum, agar agar, and guar gum;
providing a coloring agent;
combining the water with the at least one selected from the group of hydrolyzed collagen, gellan gum, xanthan gum, agar agar, and guar gum;
heating the combination of water and the at least one selected from the group of hydrolyzed collagen, gellan gum, xanthan gum, agar agar, and guar gum;
mixing the coloring agent with the heated combination of water and the at least one selected from the group of hydrolyzed collagen, gellan gum, xanthan gum, agar agar, and guar gum;
cooling the mixture of the coloring agent with the heated combination of water and the at least one selected from the group of hydrolyzed collagen, gellan gum, xanthan gum, agar agar, and guar gum to form a mass of the synthetic material, suitable for use as a thrombus simulant.

17. The method of claim 16, further comprising:
providing hydrolyzed collagen, up to 34% w/v thereof;
providing gellan gum, up to 2% w/v thereof;
providing xanthan gum, up to 1% w/v thereof;
providing agar agar, up to 1% w/v thereof; and
providing guar gum, up to 0.5% w/v thereof.

18. The method of claim 17, further comprising:
providing hydrolyzed collagen, between 25% and 34% w/v thereof;
providing gellan gum, between 0% and 2% w/v thereof;
providing xanthan gum, between 0.2% and 1% w/v thereof;
providing agar agar, between 0.2% and 1% w/v thereof; and
providing guar gum, between 0.1% and 0.5% w/v thereof.

19. The method of claim 16, wherein the combination of water and the at least one selected from the group of hydrolyzed collagen, gellan gum, xanthan gum, agar agar, and guar gum is heated to between 85° C. and 100° C., and then cooled at or below 25° C.

20. The method of claim 16, further comprising providing at least one selected from the group of a radiolucent agent and an optical brightener.
